(19) United States
(12) Patent Application Publication
(10) Pub. No.: US 2017/0129086 A1
(43) Pub. Date: May 11, 2017

(54) Fastener System

(71) Applicant: Blue Point Fasteners, Chino, CA (US)

(72) Inventor: William D. Armstrong, Chino, CA (US)

(21) Appl. No.: 15/257,894

(22) Filed: Sep. 6, 2016

Related U.S. Application Data
(60) Provisional application No. 62/189,047, filed on Jul. 6, 2015.

(51) Int. Cl. B25C 1/18; B25C 1/12

(52) U.S. Cl. CPC B25C 1/18; B25C 1/12

(57) ABSTRACT

A fastener system comprising a tool and fastener is contemplated. The tool comprises an elongated member having a longitudinal bore that receives the fastener. The fastener is driven by the tool into a working surface whereby first and second vents capture a portion of the propellant gas to optimize penetration of the fastener and reduce the sound level. The fastener typically has a first diameter and a second diameter that meet at a step. A washer can receive the first diameter of the fastener. It is contemplated that the alignment of the fastener as it penetrates the work surface is maintained by at least one of (i) the head of the fastener and the longitudinal bore, (ii) washer, and (iii) a clip to reduce failures and spalling.

This application claims the benefit of priority to U.S. Provisional Application Ser. No. 62/189,047 filed on Jul. 6, 2015. All extrinsic materials identified herein are incorporated by reference in their entirety.

### FIELD OF THE INVENTION

The field of the invention is fastener systems and more particularly explosively driven fastener systems.

### BACKGROUND

The background description includes information that may be useful in understanding the present invention. It is not an admission that any of the information provided herein is prior art or relevant to the presently claimed invention, or that any publication specifically or implicitly referenced is prior art.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Fastener systems have been developed to drive fasteners through hard structures, such as wood, concrete, masonry and steel. One example of a type of fastener system used to drive fasteners through hard structures is an explosively-driven fastener system. Typically, an explosively-driven fastener system comprises a tool that receives a fastener and a charge. When the charge is detonated, the fastener is driven from the tool and through a hard structure by gas produced by the detonated charge.

While typical driven fastener systems assist in driving a fastener through a hard surface, several drawbacks can make limit the application of such fastener systems. For example, fastener systems can overdrive the fastener through the structure, which can limit some fastener systems to specific structures. In another example, some fastener systems can produce excessive sound levels and/or provide inadequate penetration of the fastener through a structure due to misalignment of the fastener with respect to the structure.

U.S. Pat. No. 3,172,123 to Helderman discloses an explosive actuated tool for driving a fastening stud. The fastening stud is inserted into the bore of the tool adjacent to an explosive charge. When the stud strikes a work piece the stud impacts the charge to produce an explosion that drives the stud into the work piece. Helderman discloses that a guide washer can be affixed to the stud and placed in the muzzle end of the tool to align the stud in the bore. Furthermore, Helderman discloses ports that can be used to couple the bore with an expansion chamber to dissipate the explosive force of the charge and reduce recoil.

Similarly, U.S. Pat. Nos. 3,797,721 and 4,899,919 to Clump discloses a fastening system for energizing a fastener into a material (e.g., concrete) comprising a centering member/guide washer disposed on the fastener. Venting apertures or pathways receive expanding gases as the head of the fastener is driven past the venting apertures or pathways to relieve the pressure driving the fastener. U.S. Pat. No. 5,423,469 to Armstrong and U.S. Pat. No. 8,397,969 to Masas describe other venting systems for self-powered fastener systems.

Although these references address some drawbacks of fastener systems, it should be appreciated that additional improvements can further reduce or eliminate drawbacks in such systems. Thus, there is still a need in the art for improved fastener systems.

### SUMMARY OF THE INVENTION

The inventive subject matter provides apparatus, systems, and methods in which an improved fastener system can reduce, or even eliminate, drawbacks encountered in typical fastener systems. For example, fastener systems are contemplated that (i) provide optimal penetration of a fastener into a work surface, (ii) align and guide the fastener into the work surface, and (iii) reduce the sound level of the system. Thus, contemplated systems maintain the orientation of the fastener from insertion into a fastener tool until optimum penetration to thereby provide additional stability and guidance of the fastener, and improve performance of the fasteners by reducing failures and spalling.

In a contemplated embodiment, a tool for driving a fastener into a work surface comprises an elongated member having a longitudinal bore that is accessible through an opening. The longitudinal bore comprises a first inner diameter, and a recess disposed at the opening comprises a second inner diameter. Typically, the second inner diameter is larger than the first inner diameter. A first vent having an inlet is disposed on an inner surface of the recess, and a second vent having an inlet is disposed on an inner surface of the longitudinal bore. It should be appreciated that the vent locations are suitable to capture propellant gases produced by an explosive charge to thereby reduce the volume of sound and prevent overdriving the fastener through the work surface.

The first vent can be longitudinally separated from the second vent by a first distance. Typically, the first distance is greater than or equal to the length of a head portion of the fastener. It should be appreciated that the distance between the first vent and the second vent can impact the driving force of the fastener. On the one hand, if the first vent and the second vent are separated by too far of a distance then there may not be enough driving force to adequately drive the fastener through the working surface. On the other hand, if the first vent and the second vent are too close to each other then there may be a risk of overdriving the fastener. Typically, the first vent is adjacent to a first plurality of vents, and the second vent is adjacent to a second plurality of vents.

A chamber can be circumferentially disposed about the elongated member to receive any propellant gases through an outlet of each of the first and second vents. The first and second vents are typically angled with respect to a longitudinal axis of the elongated member. In other words, the first and second vents typically extend at an angle away from the distal end of the elongated member. Furthermore, the second vent can be flared, such that the vent gradually widens from the inlet to the outlet.

In another aspect, a fastener system comprising a tool, a fastener, and a washer is contemplated. The tool has an elongated member having a proximal end and a distal end, and a longitudinal bore having an inner diameter. The longitudinal bore is accessible through an opening in the distal end of the elongated member. The fastener comprises a head portion and a body portion whereby the inner diameter of the longitudinal bore of the tool is sized and dimensioned to receive the head portion of the fastener. The body portion of the fastener has a first diameter and a second diameter that meet at a step. The washer has a through-hole sized and dimensioned to receive the first diameter of the fastener, and the through-hole is smaller than the second diameter. When the washer is coupled with the elongated member, it should be appreciated that the step of the fastener helps uncouple the washer from the elongated member as the fastener is driven out of the longitudinal bore.

The tool of the fastener system can comprise a first vent and a second vent. The distance between the first and second vents and the distal end of the tool is suitable for capturing gases produced when firing the tool to improve penetration of the fastener. Typically, the step of the fastener is positioned on the body portion of the fastener such that the head portion of the fastener passes the first vent before the step contacts the washer after the tool is fired.

In another aspect, a fastener system comprising a tool and a washer is contemplated. The tool is typically for driving a fastener into a work surface. The tool comprises an elongated member having a proximal end and a distal end, and a longitudinal bore having an inner diameter. The longitudinal bore is accessible through an opening in the distal end of the elongated member. The tool further comprises a recess disposed at the opening having a tapered inner diameter. Typically, the tapered inner diameter gradually increases towards the distal end. The washer has an outer diameter that is larger than a portion of the tapered inner diameter of the recess. It should be appreciated that the washer is preferably sized and dimensioned to seal the vent when the washer is inserted into the recess.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a perspective view of a zero standoff explosively driven fastener system.

FIG. 2 is a side view and partial cross-sectional view of the fastener system of FIG. 1.

FIG. 3 is an exploded view of the fastener system of FIG. 1.

FIG. 4 is a side view of the barrel component of the fastener system of FIG. 1.

FIG. 5 is a cross-sectional view of the barrel of FIG. 4.

FIG. 6 is an enlarged cross-sectional view of the distal end of the barrel of FIG. 4.

FIG. 7 is a front view of the distal end of the barrel of FIG. 4.

FIG. 8 is a side view of a fastener, washer, and clip.

FIG. 9a is a side view of the fastener of FIG. 8.

FIG. 9b is another side view of the fastener of FIG. 8.

FIG. 9c is a top view of the head portion of the fastener of FIG. 8.

FIG. 10a is a side view of the washer of FIG. 8.

FIG. 10b is a side view of the washer of FIG. 8 in a flexed configuration.

FIG. 11a is a side view of the clip of FIG. 8.

FIG. 11b is a top view of the clip of FIG. 8.

FIG. 12a is cross-sectional view of the barrel of FIG. 4 and the nail, washer, and clip of FIG. 8 in a loaded position.

FIG. 12b is cross-sectional view of the barrel of FIG. 4 and the nail, washer, and clip of FIG. 8 in a firing position.

FIG. 12c is cross-sectional view of the barrel of FIG. 4 and the nail, washer, and clip of FIG. 8 in a first partially ejected position.

FIG. 12d is cross-sectional view of the barrel of FIG. 4 and the nail, washer, and clip of FIG. 8 in a second partially ejected position.

FIG. 12e is cross-sectional view of the barrel of FIG. 4 and the nail, washer, and clip of FIG. 8 in a third partially ejected position.

FIG. 12f is cross-sectional view of the barrel of FIG. 4 and the nail, washer, and clip of FIG. 8 in a fourth partially ejected position.

FIG. 12g is cross-sectional view of the barrel of FIG. 4 and the nail, washer, and clip of FIG. 8 in a fifth partially ejected position.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Also, as used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

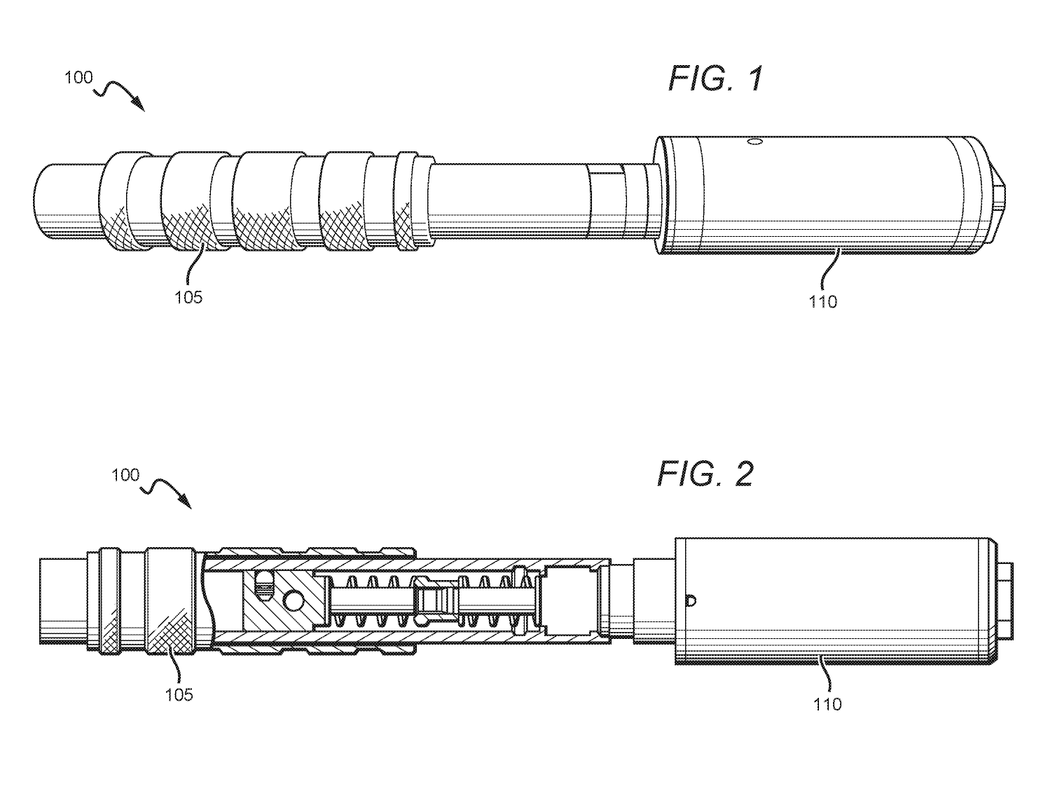

FIG. 1 shows a perspective view of a zero standoff tool 100. Tool 100 is used for driving a fastener such as a pin or nail into a work surface (e.g., wood, concrete, masonry and steel, other hard substrates or structures, etc.). Tool 100 has a handle portion 105 for holding and operating tool 100, and a driving end 110 from which the fastener is discharged (i.e., fired, ejected, etc.). Various configurations for explosively driven tools are disclosed in U.S. Pat. Nos. 3,665,583, 3,805,472, 5,544,800, 8,397,969, and 5,904,284, which are incorporated herein by reference in their entirety.

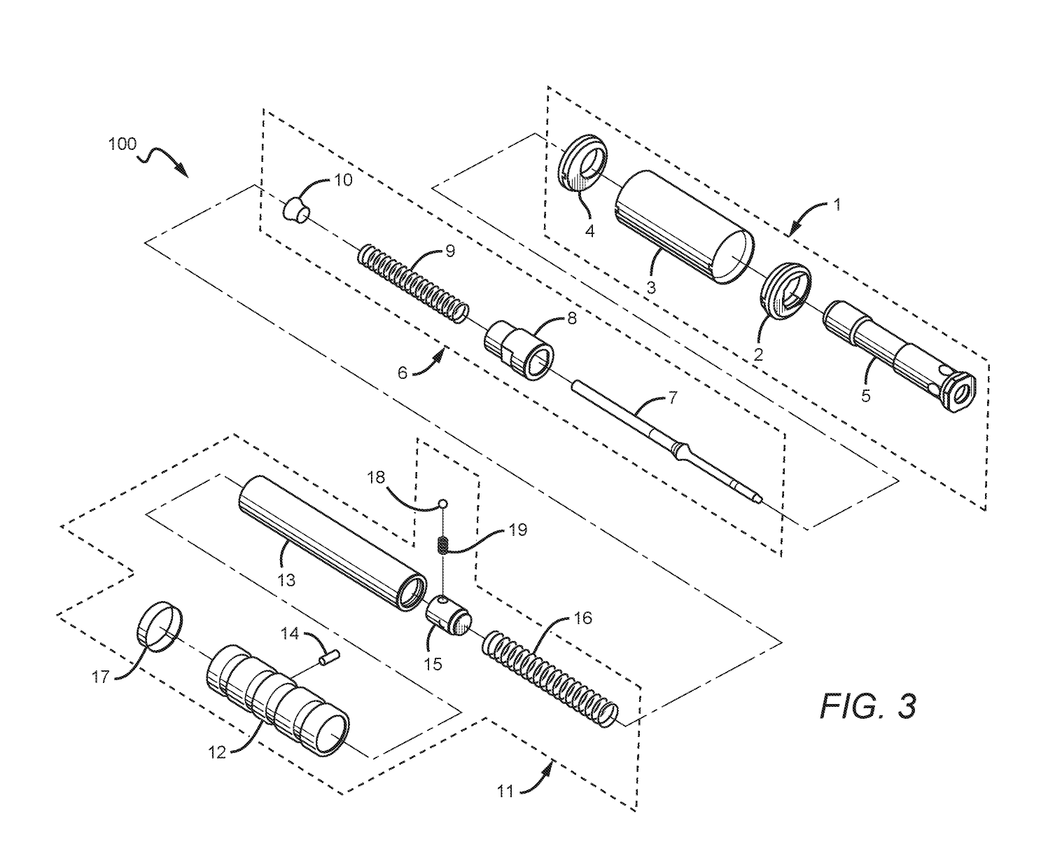

FIG. 2 shows a side view of tool 100 and a partial cross-sectional view of handle portion 105. FIG. 3 shows an exploded view of tool 100. Tool 100 comprises: a barrel assembly 1, which includes a top plate 2, a gas expansion cylinder shield 3, a bottom plate 4, a barrel 5; an ejector assembly 6, which includes an ejector 7, a pole connector 8, an ejector pin spring 9, an ejector pin spring retainer 10; and an ejector sleeve assembly 11, which includes an ejector sleeve 12, a tube 13, and stop in 14, an ejector holder 15, an ejector sleeve spring 16, an annular spring 17, a ball 18, and a spring 19.

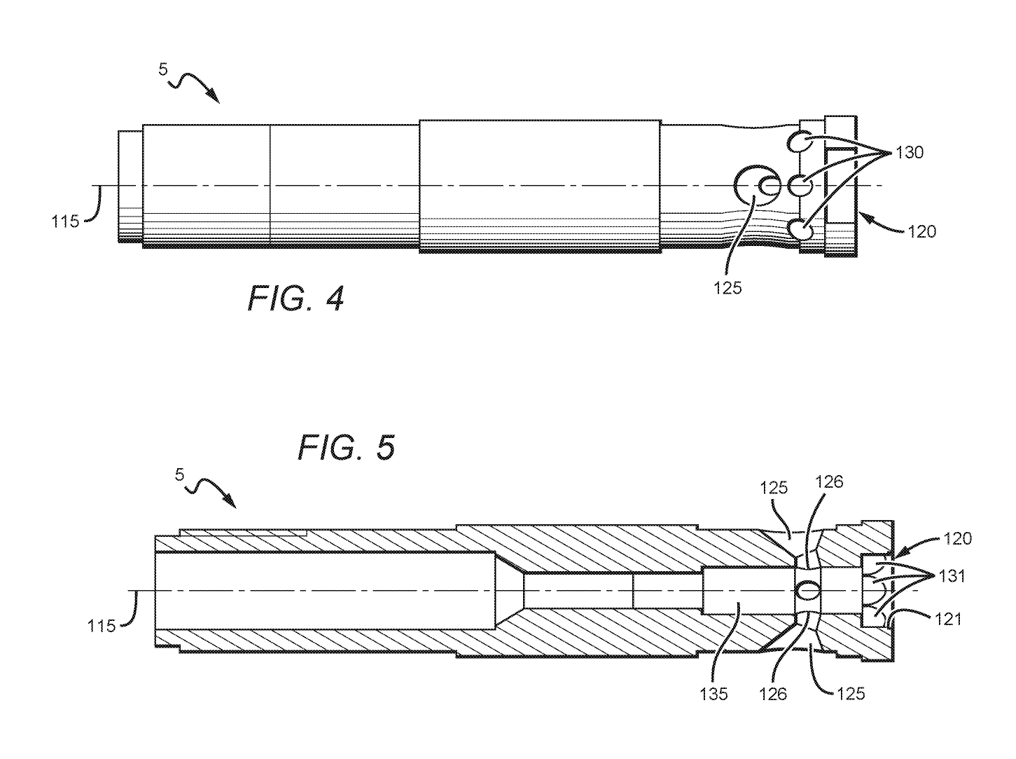

FIG. 4 shows a side view of barrel 5 (also referred to as elongated member). Barrel 5 has a longitudinal axis 115, an opening 120, a first set of vent outlets 125, and a second set of vent outlets 130. Typically, the vent outlets are fluidly coupled to an expansion chamber (e.g., a gas expansion cylinder shield) that is sized and dimensioned to receive propellant gases from a charge. First set of vent outlets 125 are typically larger than second set of vent outlets 130. Moreover, it is contemplated that second set of vent outlets 130 can be circumferentially disposed on the exterior surface of barrel 5. As shown in FIG. 4, second set of vent outlets 130 are disposed closer to a distal end of barrel 5 than first set of vent outlets 130.

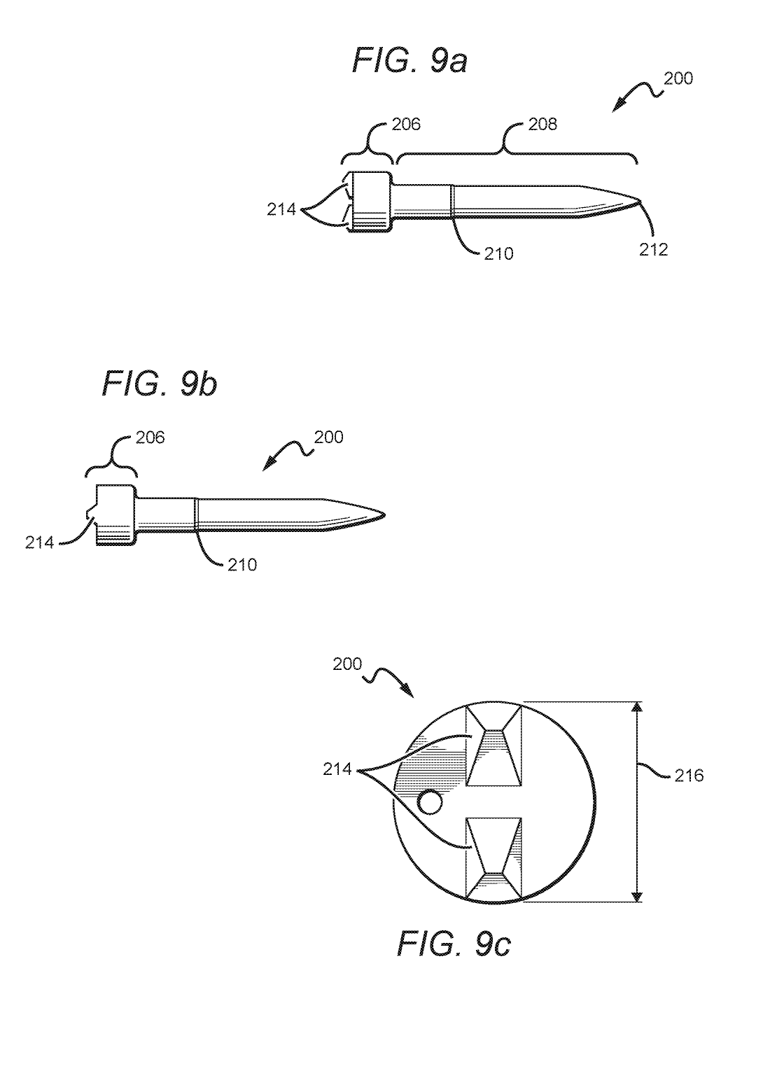

FIG. 5 shows a cross-sectional view of barrel 5. Opening 120 has a recess 121 that provides access to a longitudinal bore 135. It is contemplated that recess can be tapered to gradually decrease in diameter as it extends away from the distal end of barrel. A first set of vent inlets 126 are located on the inner surface of bore 135 and are fluidly coupled with vent outlets 125. A second set of vent inlets 131 are located on the inner surface of recess 121 and are fluidly coupled with the second set of vent outlets 130. First set of vent inlets 126 and second set of vent inlets 131 are typically separated by a longitudinal distance. It is contemplated that the longitudinal distance is equal to or greater than the length of a head portion of a fastener (see head portion 206 in FIG. 9a).

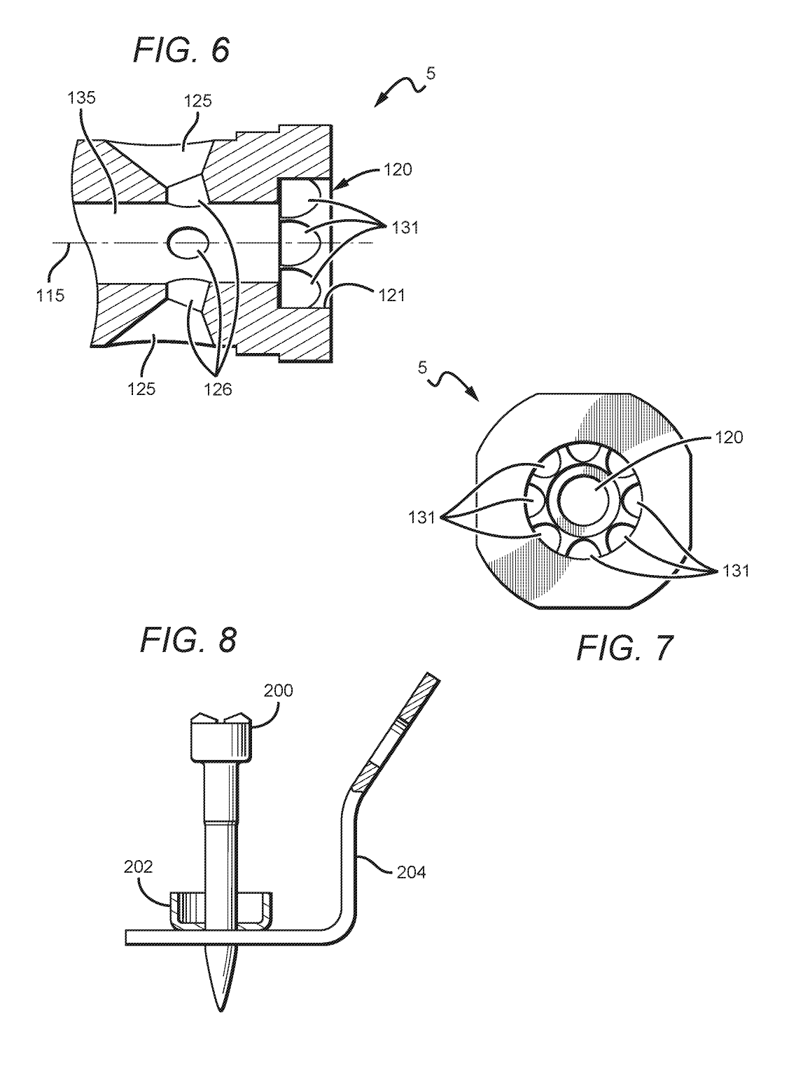

FIG. 6 shows an enlarged cross-sectional view of the distal end of barrel 5. First set of vent inlets 126 are typically angled and flared. For example, as shown in FIG. 6, first set of vent inlets 126 extend to first set of vent outlet 125 are angled with respect to longitudinal axis 115, and most typically first set of vent inlets 126 extent to first set of vent outlets 125 at an angle away from the distal end of barrel 5. Similarly, it is contemplated that second set of vent inlets 131 extend to second set of vent outlets 130 at an angle with respect to longitudinal axis 115, and most typically, second set of vent inlets 131 extend to second set of vent outlets 130 extend at an angle away from the distal end of barrel 5. Additionally, or alternatively, first set of vent inlets 126 extends to first set of vent outlets, such that vent gradually widens (e.g., are flared) from the inlets to the outlets.

FIG. 7 shows a front view of the distal end of barrel 5 of FIG. 4. Distal end of barrel 5 comprises second set of vent inlets 131 and opening 120. It is contemplated that second set of vent inlets 131 can comprise eight vent inlets that are circumferentially disposed around opening 120. It should be appreciated that more or less vent inlets are contemplated in second set of vent inlets 131. It should be appreciated that the various vents disposed on barrel 5 are sized, dimensioned, and positioned to capture propellant gas from an explosive charge as the fastener is driven out of longitudinal bore 135. The vents can collectively capture propellant gas at the same time or in stages as the fastener travels along longitudinal bore (e.g., first set of vent inlets 126 and then second set of vent inlets 131 receive propellant gas.

FIG. 8 shows a fastener 200, a washer 202, and a clip 204 that can be used in conjunction with the fastening tool as described herein. Fastener 200 can be inserted in the barrel of fastening tool to drive fastener 200 into a work surface. It is contemplated that fastener 200 can be many suitable attachment devices, such as a nail, a bolt, and a screw, and fastener 200 can be either threaded or not threaded. Fastener 200 is typically composed of a material having a strength sufficient to penetrate a work surface without fracturing.

Washer 202 has a through-hole that receives fastener 200. Washer 202 can comprise at least one of a metal and a polymer. For example, washer 202 can comprise all metal, all nylon or some other hard polymer, or a combination of a metal and polymer (e.g., a steel washer with a nylon coating). Typically, washer 202 can flex to fit into a recess of the barrel (see, e.g., recess 121 in FIG. 5) and create a seal. For example, where the recess of barrel is tapered to decrease gradually as described above, it is contemplated that the outer diameter of washer 202 is larger than a portion of the inner diameter of the tapered recess, such that washer 202 is inserted into recess until the outer diameter of washer 202 flexes due to the smaller inner diameter of the recess to provide a coupling. It should be appreciated that a nylon coating can allow for more flexing and can be easier to slide against in inner surface of recess as opposed to a metal washer.

Clip 204 can also be coupled to fastener 200 whereby a fastening tool can be used to drive fastener 200 into a work surface to attach clip 204 onto the work surface. It is contemplated that clip 204 can be an angle clip (e.g., L-shaped clip or 90° angle clip, 120° angle clip, etc.), a conduit clip, and any other suitable attachment device as desired by the user. Clip 204 can be used to attach a wire or other item to the work surface.

A side view of fastener 200 is shown in FIG. 9a. Fastener 200 comprises a head portion 206 and a body portion 208 that meet at a shoulder. Body portion 208 comprises a step 210 that separates a first diameter and a second diameter of body portion 208. The second diameter comprises body portion 208 from step 210 to head portion 206, and first diameter comprises body portion 208 from step 210 to an area adjacent to a tapered point 212 on body portion 208 of fastener 200. As shown in FIG. 9a, second diameter is larger than first diameter. However, it is contemplated that the first diameter can be larger than the second diameter or that the first diameter is equal to the second diameter.

Projections 214 can be disposed on one end of fastener 200 that are used to detonate a charge within a fastening tool. Preferably, projections 214 are disposed on an end of fastener 200 that is proximal to head portion 206. Projections 214 comprise a pointed apex that assists in detonating the charge. FIG. 9b shows another side view of fastener 200 having a step 210. As shown in FIG. 9b, it is contemplated that the projections 214 can be aligned on one end of fastener 200.

FIG. 9c shows a top view of the head portion 206 of fastener 200. As described above, head portion 206 can comprise projections 214. It is contemplated that head portion 206 can comprise a diameter 216 as shown in FIG. 9c. It is contemplated that diameter 216 is slightly smaller than an inner diameter of a bore of a barrel (see, e.g., bore 135 in FIG. 5) to maximize the force on fastener 200 by propellant gases produced from an explosive charge. In other words, diameter 216 and the inner diameter of the bore of the barrel are similar sizes to prevent propellant gas from escaping between the inner surface of the bore of the barrel and the outer surface of the head portion 206 of fastener 200. In contemplated embodiments, diameter 216 and an inner diameter of the bore of the barrel are within 0.01% to 25% of each other, or within 0.5% to 15% of each other, or 1% to 10% of each other.

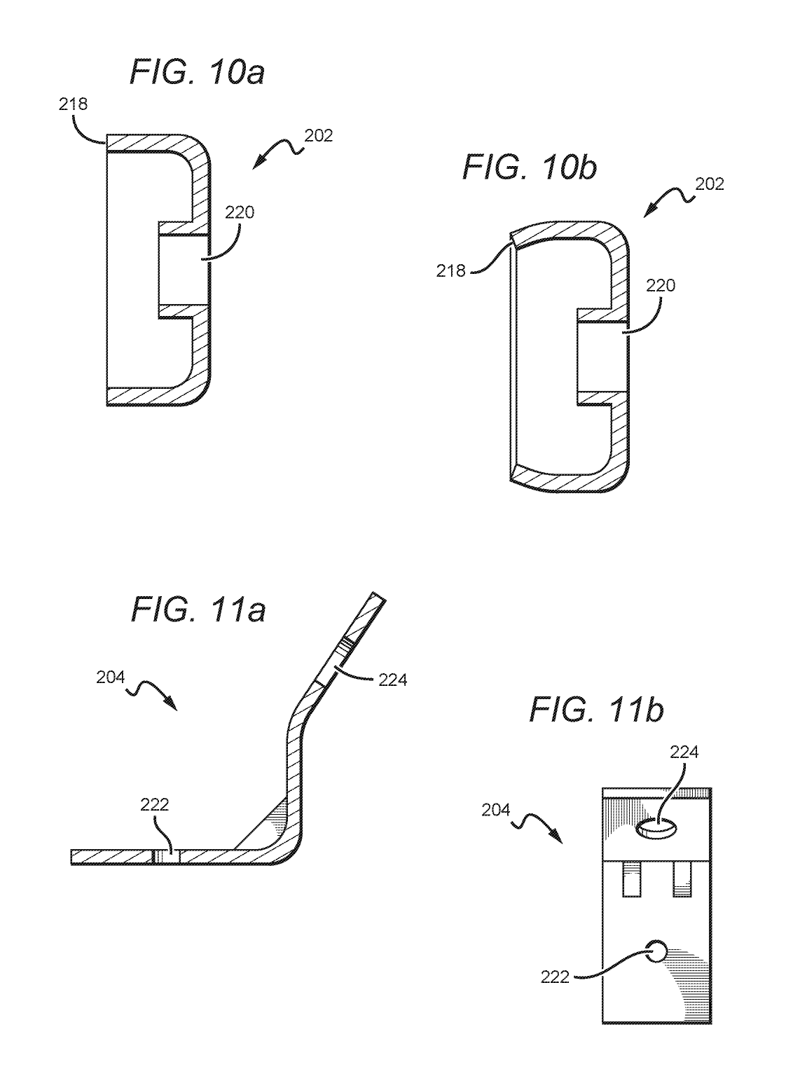

A washer 202 can comprise an annular flange 218 as shown in FIG. 10a. Annular flange 218 is disposed about a through-hole 220 of washer 202 and is configured to flex as shown in FIG. 10b. Annular flange 218 can flex to fit within a recess of a barrel of a fastening tool (see, e.g., recess 121 in FIG. 5). For example, annular flange 218 can flex when compressed due to the recess of barrel having tapered walls that decrease in diameter. It should be appreciated that washer 202 can provide a seal between the outer environment and (i) the opening of barrel (see, e.g., opening 120 in FIG. 6) and (ii) a second set of vents (see, e.g., second set of vent inlets 131 in FIG. 6). Thus, washer 202 can be used to contain propellant gases from a detonated charge in the fastening tool.

While not shown, it is contemplated that annular flange 218 can comprise a coating (e.g., nylon coating) to more easily flex and slide into the recess of the barrel. In other contemplated embodiments, washer 202 can be a solid piece (i.e., no empty areas between outer surface and through-hole 220) with through-hole 220. In such embodiment, washer 202 can comprise a polymer material that is flexible to fit within the recess of the barrel.

Through-hole 220 is sized and dimensioned to receive a body portion 208 of fastener 200. In some embodiments, through-hole 220 engages body portion 208 of fastener in a friction fit. It is contemplated that through-hole 220 is sized and dimensioned to receive the first diameter of fastener 200 (i.e., body portion 208 on side of step 210 distal of head portion 206) and that through-hole 220 is smaller than the second diameter of fastener 200 (i.e., body portion 208 on side of step 210 proximal of head portion 206). When fastener 200 is driven out of the fastener tool, it is contemplated that through-hole 220 can expand to accommodate the second diameter, such that head portion 206 will rest on annular flange 218 when fastener 200 is driven into a work surface.

FIGS. 11a and 11b show different views of clip 204. Clip comprises a first opening 222 and a second opening 224. First opening 222 is sized and dimensioned to couple to fastener 200 as shown in FIG. 8. Similar to washer 202, it is contemplated that first opening 222 is sized and dimensioned to receive the first diameter of fastener 200 (i.e., body portion 208 on side of step 210 distal of head portion 206) and that first opening 222 is smaller than the second diameter of fastener 200 (i.e., body portion 208 on side of step 210 proximal of head portion 206). When fastener 200 is driven out of the fastener tool, it is contemplated that first opening 222 can expand to accommodate the second diameter. Second opening 224 can be used to hang a wire or other item once fastener 200 and clip 204 are attached to a work surface.

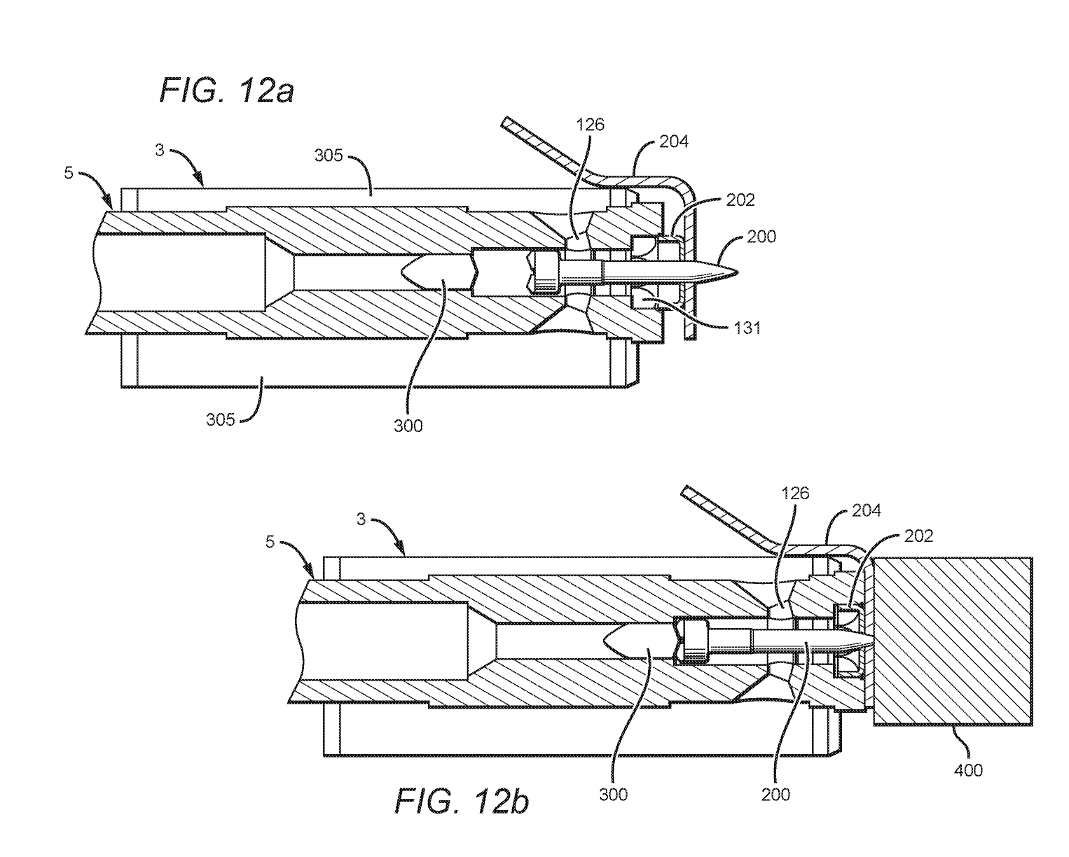

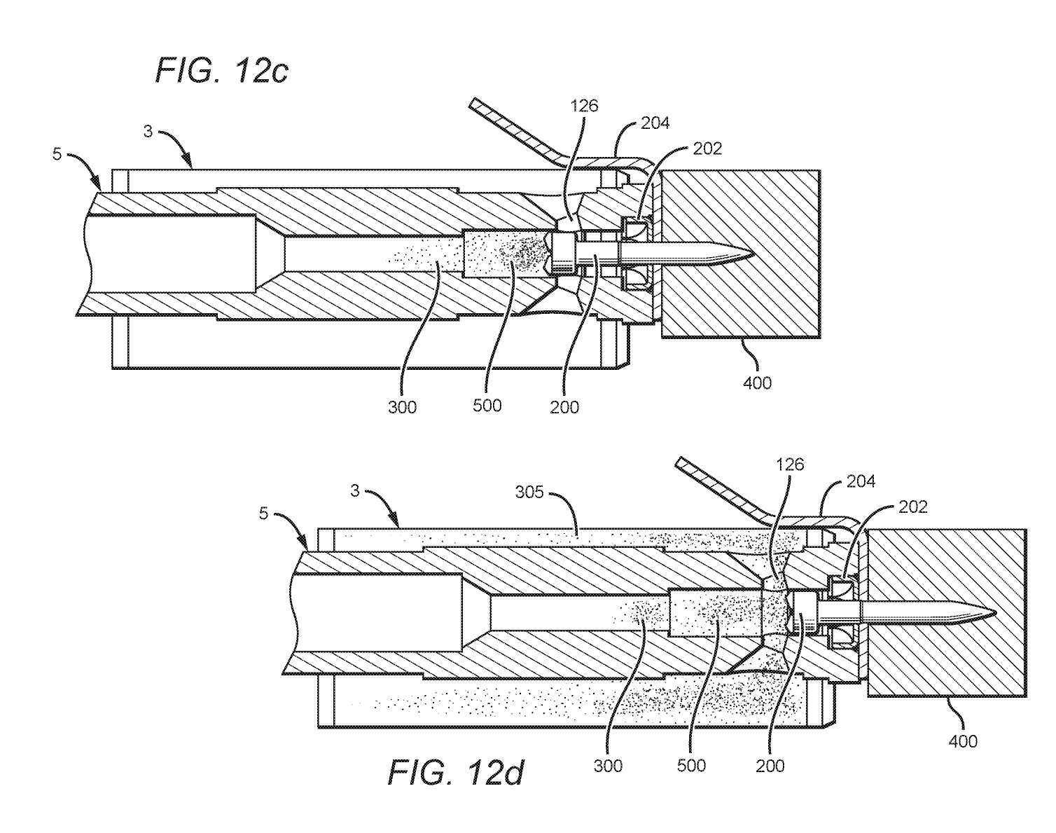

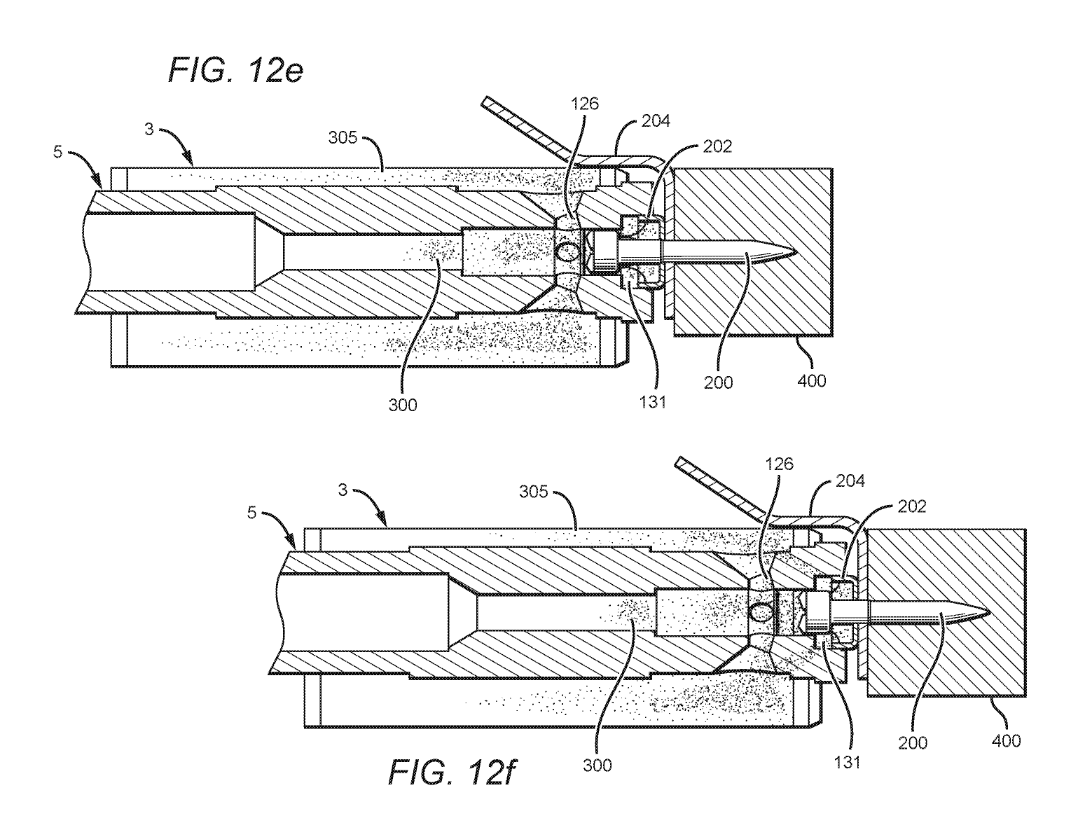

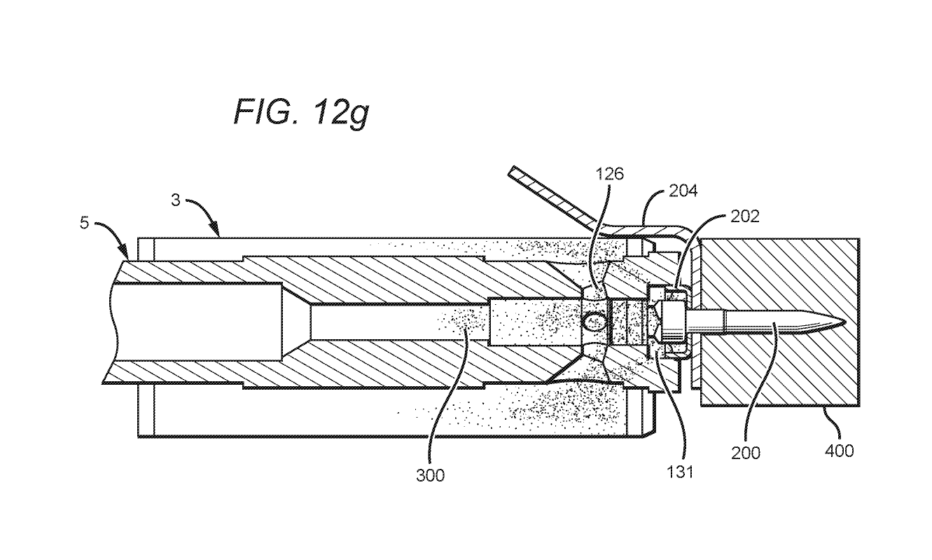

An exemplary illustration of use of a fastener tool to drive a fastener is shown in FIGS. 12a-12g.

FIG. 12a shows a cross-sectional view of the distal end of tool 100, with a charge 300, and fastener 200, washer 202, and clip 204 in a loaded position. In the loaded position, a user has placed the head portion 206 of fastener 200 inside of bore 135. Head portion 206 is separated from charge 300 by a distance. Washer 202 is partially disposed in recess 121 but is not fully seated. Clip 204 is disposed near the distal end of barrel 5, but is not yet in contact with the distal end. In the loaded position, tool 100 is ready to be pressed against a work surface to fully seat fastener 200, washer 202, and clip 204.

Barrel 5 and gas expansion cylinder shield 3 form a chamber 305 that is fluidly coupled with vent outlets 125 and vent outlets 130. Chamber 305 allows gases from the ignition and explosion of charge 300 to escape, thereby reducing the velocity of fastener 200 and reducing the noise of the explosion, as will be further explained in more detail below.

FIG. 12b shows fastener 200, washer 202, and clip 204 in a loaded position in a firing position. In this position, the user has pressed tool 100 against a work surface 400, causing point 212 of fastener 200 to penetrate into work surface 400 and head portion 206 to travel deeper into bore 135 against charge 300. In addition, washer 202 has been pushed deeper into recess 121, causing washer 202 to flex (as shown in FIG. 10b) against the tapered walls of recess 121 and causing annular flange 218 to seal off vent inlets 131 and the distal end of barrel 5. Clip 204 is now also fully seated and sits in contact with the distal end of barrel 5.

In the firing position, this fastener system provides three points of stabilization that guide fastener 200 in a straight path as it penetrates work surface 400: (i) the first point of stabilization is provided by the tight tolerances between head portion 206 and the inner diameter of bore 135; (ii) the second point of stabilization is provided by tight tolerances between recess 121, washer 202, and body portion 208; (iii) the third point of stabilization is provided by tight tolerances between body portion 208 and clip 204, in combination with the friction between the distal end of barrel 5, clip 204, and work surface 400. Since washer 202 is held in place within recess 121 (due to the tapered walls of recess 121 and the flexing of annular flange 218), the three points of stabilization provide guidance and stability throughout the majority of fastener 200's travel time. This reduces the amount of failures compared to conventional zero standoff tools.

In the fully seated and firing position, projections 214 on head portion 206 of fastener 200 are pressed into charge 300, causing charge 300 to ignite and explode. FIG. 12c shows a cross-sectional view of tool 100 in a fired and partially ejected position. The ignition of charge 300 has caused a gas 500 to push head portion 206 of fastener 200 forward, advancing tapered point 212 further into work surface 400. As head portion 206 reaches vent inlets 126 on the inner surface of bore 135, as shown in FIG. 12d, gas 500 dispenses into chamber 305. This dissipates some of the energy pushing fastener 200 forward and also reduces the noise that will eventually exit the distal end of barrel 5 once fastener 200 is completely ejected.

FIG. 12e step 210 has reached washer 202 and has started to push washer 202 out of recess 121. The tight tolerance between through-hole 220 and body portion 208 may also cause through-hole 220 to elongate. However, the flexing force of annular flange 218 is strong enough to keep washer 202 at least partially disposed in recess 121. The partial dislodgment of washer 202 from recess 121 has started to unseal vent inlets 131 and has allowed some of gas 500 to begin to enter vent inlets 131. In addition, the distal end of barrel 5 has been pushed off of clip 204 and work surface 400.

Once head portion 206 of fastener 200 reaches recess 121, gas 500 can move freely into chamber 305, as shown in FIG. 12f, thereby dissipating more of the explosion energy and reducing the speed of fastener 200. This also reduces more noise from being emitted out of the distal end of barrel 5.

FIG. 12g shows fastener 200 in its final stage of ejection. In this position, the shoulder of head portion 206 has reached washer 202, causing washer 202 to completely loosen from its flexed position inside recess 121. The material of washer 202, tapered walls of recess 121, length of fastener 200, size and shape of vents outlets 125 and 130, strength of charge 300, and inner diameter of bore 135 have all been selected and configured such that noise reduction has been greatly reduced while still providing enough drive power to fully penetrate work surface 400. These parameters can be adjusted based on the hardness and thickness of work surface 400 (e.g., concrete, hardwood, metal, etc.). These parameters have also been configured to eliminate (or greatly reduce) the risk of free flight (e.g., over penetration of fastener 200 out the back of work surface 400).

Thus, specific compositions and methods of fastener systems have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A tool for driving a fastener into a work surface, comprising:
an elongated member having a longitudinal bore that is accessible through an opening, wherein the longitudinal bore has a first inner diameter;
a recess disposed at the opening and having a second inner diameter, wherein the second inner diameter is larger than the first inner diameter;
a first vent having an inlet disposed on an inner surface of the recess; and
a second vent having an inlet disposed on an inner surface of the longitudinal bore.

2. The tool of claim 1, wherein the first vent is longitudinally separated from the second vent by a first distance.

3. The tool of claim 2, further comprising a fastener comprising a head portion and a body portion, wherein the head portion and the body portion meet at a shoulder.

4. The tool of claim 3, wherein the first distance is greater than or equal to the length of the head portion.

5. The tool of claim 1, wherein the first vent is angled.

6. The tool of claim 1, wherein the second vent is angled and flared.

7. The tool of claim 1, further comprising a chamber circumferentially disposed about the elongated member.

8. The tool of claim 7, wherein the first vent and the second vent each comprise an outlet fluidly coupled with the chamber.

9. The tool of claim 1, further comprising a plurality of vents circumferentially disposed on the inner surface of the recess.

10. A fastener system, comprising:
a tool, comprising:
an elongated member having a proximal end and a distal end;
a longitudinal bore having an inner diameter, the bore being accessible through an opening in the distal end of the elongated member;
a fastener comprising a head portion and a body portion, wherein the head portion and body portion meet at a shoulder;
wherein the inner diameter of the longitudinal bore of the tool is sized and dimensioned to receive the head portion of the fastener;
wherein the body portion of the fastener comprises a first diameter and a second diameter that meet at a step; and
a washer having a through-hole sized and dimensioned to receive the first diameter of the fastener and wherein the through-hole is smaller than the second diameter.

11. The fastener system of claim 10, wherein the tool further comprises:
a first vent located at a first distance from the distal end; and
a second vent located at a second distance from the distal end, wherein the second distance is greater than the first distance.

12. The fastener system of claim 11, wherein the first and second distances are suitable for capturing gases produced when firing the tool to improve penetration of the fastener. (this is probably too vague)

13. The fastener system of claim 11, wherein the step is positioned on the body portion of the fastener such that the head portion of the fastener passes the first vent before the step contacts the washer after the tool is fired.

14. The fastener system of claim 10, wherein the through-hole on the washer is slightly larger than the first diameter of the body portion of the fastener.

15. The fastener system of claim 10, wherein fastener comprises a tapered point.

16. A fastener system, comprising:
a tool for driving a fastener into a work surface, comprising:
an elongated member having a proximal end and a distal end;
a longitudinal bore having an inner diameter, wherein the bore is accessible through an opening in the distal end of the elongated member;
a recess disposed at the opening and having a tapered inner diameter, wherein the tapered inner diameter gradually increases towards the distal end; and
a washer having an outer diameter that is larger than a portion of the tapered inner diameter of the recess.

17. The fastener system of claim 16, wherein the washer has an annular flange.

18. The fastener system of claim 17, wherein the annular flange comprises a thickness and a material suitable to flex when the washer is inserted into the recess.

19. The fastener system of claim 16, wherein an inner surface of the recess comprises an inlet of a vent.

20. The fastener system of claim 19, wherein the washer is sized and dimensioned to seal the vent when the washer is inserted into the recess.
